(19) United States
(12) Patent Application Publication
(10) Pub. No.: US 2025/0285073 A1
(43) Pub. Date: Sep. 11, 2025

(54) HANDLING DISCREPANCIES BETWEEN ORDERED AND DELIVERED ITEMS AT THE TIME OF DELIVERY

(71) Applicant: MOTOROLA MOBILITY LLC, WILMINGTON, DE (US)

(72) Inventors: KRISHNAN RAGHAVAN, BANGALORE (IN); VIJAYPRAKASH IDLUR, IDLUR (IN); A G PRASAD, BANGALORE (IN)

(21) Appl. No.: 18/601,897

(22) Filed: Mar. 11, 2024

(51) Int. Cl. G06Q 30/0601

(52) U.S. Cl. CPC G06Q 30/0629; G06Q 30/0637

(57) ABSTRACT

An electronic device, computer program product, and method autonomously verifies accuracy of delivery of purchased items. The electronic device: receives information of a first order requested from a source, including a delivery address for the first order; captures a first image of one or more items included in the first order at the source for delivery; subsequently captures, a second image comprising all items that were delivered contemporaneously with presenting the first order at the delivery address; and initiates a comparison of the delivered items within the second image with the one or more items within the first image. In response to identification of a material discrepancy between the delivered items in the second image and the items in the first image, the processor presents a notification indicating the material discrepancy and presents at least one corrective action required to be taken to address the material discrepancy.

### BACKGROUND

### 1. Technical Field

The present disclosure relates generally to delivery management by electronic devices and in particular to electronic devices used by delivery agents to manage deliveries of items at the delivery location.

### 2. Description of the Related Art

Managing deliveries of items ordered by purchasers presents many challenges for sellers and the delivery agents. For example, challenges are often encountered with delivery scheduling and delivery accuracy. Typically, the purchasers or recipients have the expectations that their deliveries occur during the promised time window and that the items delivered are exactly the items that were ordered and in the condition that they expect. With regard to delivery accuracy, it is not uncommon for a delivery to include a wrong item or a damaged item, or to be missing a certain item, all issues that are typically discovered by the recipient at a later time after the delivery is completed.

### BRIEF DESCRIPTION OF THE DRAWINGS

The description of the illustrative embodiments can be read in conjunction with the accompanying figures. It will be appreciated that for simplicity and clarity of illustration, elements illustrated in the figures have not necessarily been drawn to scale. For example, the dimensions of some of the elements are exaggerated relative to other elements. Embodiments incorporating teachings of the present disclosure are shown and described with respect to the figures presented herein, in which:

FIG. 1A depicts an example electronic device within which various aspects of the disclosure can be implemented, according to one or more embodiments.

FIG. 1B depicts a functional block diagram of a communication device configured as a network server and which facilitates verification of the accuracy of a delivery of an order at the destination, and within which various aspects of the features of the present disclosure are advantageously implemented, according to one or more embodiments.

FIG. 2 depicts an example network environment within which different electronic devices of different delivery agents can access information about orders placed via an electronic order system implemented in a server computing system, according to one or more embodiments.

FIG. 3A depicts an example order receiving server that can be implemented to enable receiving orders placed for delivery from a source to a destination location, according to one or more embodiments.

FIG. 3B depicts an example delivery order verification server that can be implemented to facilitate correct delivery of orders received by the order receiving server, according to one or more embodiments.

FIG. 4 depicts an example order of items for delivery, which includes identification of the items ordered, a delivery address, and an identification of the sourcing entity/location, according to one or more embodiments.

FIG. 5A depicts capturing of a first image of an example original packing container within which different items of an order are placed at a source location to be delivered by a delivery agent to a destination location specified by the originator of the order, according to one or more embodiments.

FIG. 5B depicts capturing of a second image of an example delivered packing container of the ordered items at a destination location, while the delivered packing container is still in the possession of the delivery agent and with specific items missing, according to one or more embodiments.

FIG. 6 depicts a process of autonomously determining discrepancies in an order when the order is delivered from a source location to a destination location and determining and presenting corrective actions to be performed when one or more discrepancies are determined in the order, according to one or more embodiments.

FIG. 7 depicts a process of determining the discrepancy type associated with each identified discrepancy and generating possible corrective actions according to the discrepancy type to complete an order, according to one or more embodiments.

### DETAILED DESCRIPTION

The present disclosure provides an electronic device, a method, and a computer program product that enables autonomous verification of accuracy of delivery of items in orders placed by purchasers for delivery. According to one or more embodiments, the electronic device includes at least one image capturing device and a memory having stored thereon a delivery order verification (DOV) module or App for processing information related to orders placed by purchasers (or person placing the order to initiate the delivery) for delivery. The electronic device also includes at least one processor communicatively coupled to at least one image capturing device and the memory. The at least one processor executes program code of the DOV module to cause the processor to: (i) receive information of a first order by a person placing the order (e.g., a purchaser) from a source, the information including a delivery address for the first order; (ii) capture at the source location, via one of the at least one image capturing device, a first image comprising one or more items included in the first order for delivery to the delivery address; (iii) subsequently capture at the delivery address, via one of the at least one image capturing device, a second image comprising all items that were delivered to the delivery address, contemporaneously with presenting the first order at the delivery address; (iv) in response to receiving the second image, initiate a comparison of the delivered items within the second image with the one or more items within the first image; and (v) in response to identification of at least one material discrepancy between the delivered items in the second image and the one or more items in the first image, present at least one notification indicating the at least one material discrepancy to a delivery agent.

According to one or more embodiments, the method provides computer-implemented processes for performing order verification using an electronic device so that a delivery agent can be notified whether the items being delivered to a delivery address includes wrong/incorrect items or omits (or is missing) items ordered for inclusion in the first order. The method includes receiving information of a first order requested for delivery from a source, the information comprising a list of items to be delivered and a delivery address for the first order. The method includes capturing at the source, via one of at least one image capturing device of an electronic device, a first image comprising one or more items included in the first order for delivery to the delivery address; and subsequently capturing, via one of the at least one image capturing device of the electronic device, a second image comprising all items that were delivered at the delivery address contemporaneously with presenting the first order at the delivery address. The method also includes initiating a comparison of the delivered items within the second image with the one or more items within the first image; and in response to identification of at least one material discrepancy between the delivered items captured in the second image and the one or more items captured in the first image, presenting at least one notification indicating the at least one material discrepancy to a delivery agent.

According to one or more embodiments, following the capturing of the first image, the method further includes comparing, using artificial intelligence with image analysis features and a database of images and item names, the list of items with the items captured in the first image; and confirming that the captured first image includes all of the items on the order list of items. The method further includes, in response to the captured items matching a full complement of the list of items, presenting and storing a confirmation of the pickup order being complete. Also, in response to not having a match of the full complement of the list of items, the method includes presenting and storing a notification of the items that are missing from the captured items. The method then includes generating and outputting a prompt for addition of the missing items into the container and a retaking of the first image at the source location.

According to one or more embodiments, the disclosure includes a computer program product that includes a non-transitory computer readable storage device and program code on the computer readable storage device that when executed by a processor associated with an electronic device, the program code enables the electronic device to provide functionality of the above-described and additional method processes.

The present disclosure addresses issues that arise when items are ordered for delivery from a source to a recipient and the delivery that is completed by a delivery agent includes wrong or damaged items or omits certain items that were ordered and paid for. Often the inclusion of a wrong or damaged item or omission of an expected item is not discovered until the delivery agent has left. Once discovered, the recipient then has to take steps to handle the issue, which typically can involve investment of significant time communicating with representatives at the source, which may involve the delivery agent, and request corrections, credits, and/or refunds. The negative experience can result in frustration and dissatisfaction for the purchaser/recipient and loss of future revenue for the seller.

In the following detailed description of exemplary embodiments of the disclosure, specific exemplary embodiments in which the various aspects of the disclosure may be practiced are described in sufficient detail to enable those skilled in the art to practice the invention, and it is to be understood that other embodiments may be utilized and that logical, architectural, programmatic, mechanical, electrical, and other changes may be made without departing from the spirit or scope of the present disclosure. The following detailed description is, therefore, not to be taken in a limiting sense, and the scope of the present disclosure is defined by the appended claims and equivalents thereof. Within the descriptions of the different views of the figures, similar elements are provided similar names and reference numerals as those of the previous figure(s). The specific numerals assigned to the elements are provided solely to aid in the description and are not meant to imply any limitations (structural or functional or otherwise) on the described embodiment. It will be appreciated that for simplicity and clarity of illustration, elements illustrated in the figures have not necessarily been drawn to scale. For example, the dimensions of some of the elements are exaggerated relative to other elements.

It is understood that the use of specific component, device and/or parameter names, such as those of the executing utility, logic, and/or firmware described herein, are for example only and not meant to imply any limitations on the described embodiments. The embodiments may thus be described with different nomenclature and/or terminology utilized to describe the components, devices, parameters, methods and/or functions herein, without limitation. References to any specific protocol or proprietary name in describing one or more elements, features or concepts of the embodiments are provided solely as examples of one implementation, and such references do not limit the extension of the claimed embodiments to embodiments in which different element, feature, protocol, or concept names are utilized. Thus, each term utilized herein is to be given its broadest interpretation given the context in which that term is utilized.

As provided herein, the term “order” is not limited to only items that are being purchased, and thus the person ordering the items may not necessarily by a purchaser that is paying for the items being ordered. Thus, within the disclosure the term “purchaser” is being utilized to encompass and generally refer to someone that generates the list of items to include in the order. The term purchaser is thus also interchangeably referred to as an “order generator”, i.e., someone who generates the order. The order generator can be the person who directly enters the items in an online ordering portal. The order generator can also be the person who provides a verbal or physical list of the items for entry by personnel associated with the merchant provider/source (e.g., a store clerk communicating in person or connected via email or phone call or text messages to the order generator). Alternatively, in one or more embodiments, the order generator can be an electronic device running DOV code that is pre-programmed to generate one or more orders, such as a periodic/recurring order. Additionally, the supplier of the items in an order can be a seller, merchant, company, retailer, wholesaler, an individual supplier, a commercial supplier, etc. that provides items that are packed at a source for pickup and delivery to the delivery location. The source can be a retail location, warehouse, or other location from which the items are provided or can be a different location that serves as a pickup point from which the delivery agent can collect the ordered items. The delivery agent can be a person or a drone or an automated vehicle designed and programmed to perform deliveries of items.

As further described below, implementation of the functional features of the disclosure described herein is provided within processing devices and/or structures and can involve use of a combination of hardware, firmware, as well as several software-level constructs (e.g., program code and/or program instructions and/or pseudo-code) that execute to provide a specific utility for the device or a specific functional logic. The presented figures illustrate both hardware components and software and/or logic components.

Those of ordinary skill in the art will appreciate that the hardware components and basic configurations depicted in the figures may vary. The illustrative components are not intended to be exhaustive, but rather are representative to highlight essential components that are utilized to implement aspects of the described embodiments. For example, other devices/components may be used in addition to or in place of the hardware and/or firmware depicted. The depicted example is not meant to imply architectural or other limitations with respect to the presently described embodiments and/or the general invention. The description of the illustrative embodiments can be read in conjunction with the accompanying figures. Embodiments incorporating teachings of the present disclosure are shown and described with respect to the figures presented herein.

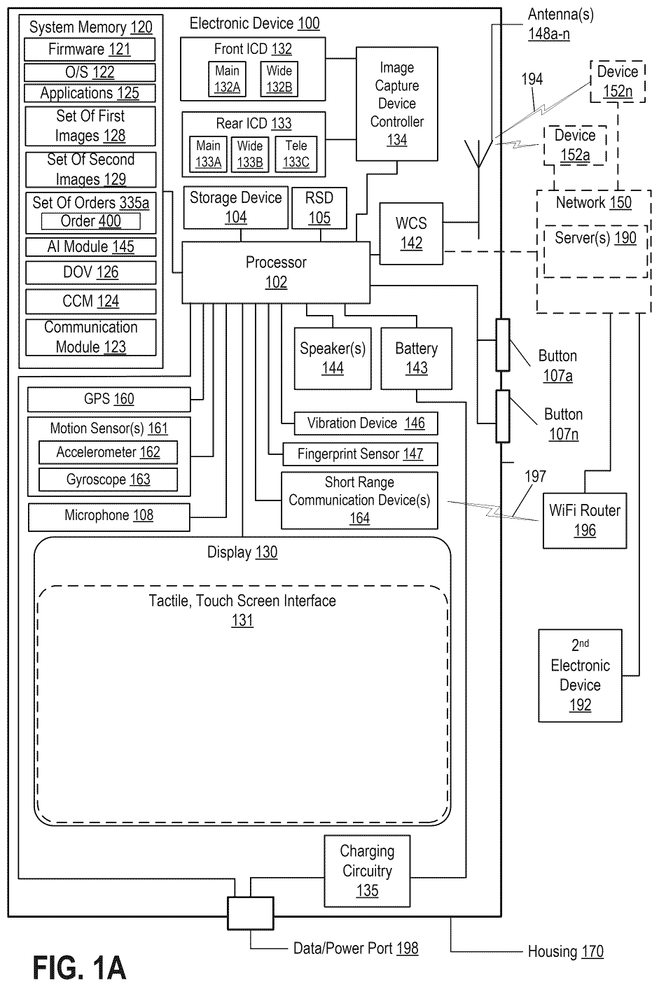

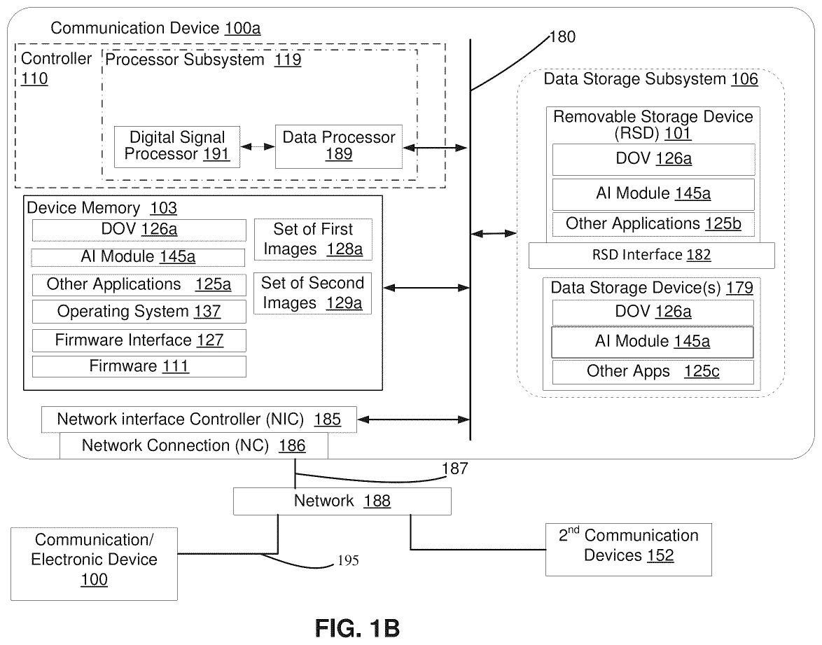

FIG. 1A depicts an example electronic device 100 within which various aspects of the disclosure can be implemented, according to one or more embodiments. Examples of such electronic devices include, but are not limited to, mobile devices, a notebook computer, a mobile phone, a digital camera, a smart watch, a tablet computer, and a communication device, etc. Electronic device 100 includes processor 102, which is communicatively coupled to storage device 104, system memory 120, input devices, introduced below, output devices, such as display 130, and image capture device (ICD) controller 134. Processor 102 can include processor resources, such as a central processing unit (CPU), that support computing, classifying, processing, and transmitting of data and information. Electronic device 100 includes a plurality of image capturing devices, presented as front and rear facing cameras 132, 133. The ICD controller 134 may perform or support functions such as, but not limited to, selecting and activating an active camera from among multiple cameras. Throughout the disclosure, the term image capturing device is utilized interchangeably to be synonymous with and/or refer to any one of front or rear facing cameras 132, 133.

System memory 120 may be a combination of volatile and non-volatile memory, such as random-access memory (RAM) and read-only memory (ROM). System memory 120 can store program code or similar data associated with firmware 121, an operating system 122, communication module 123, camera control module (CCM) 124, applications 125, delivery order verification (DOV) module 126, and artificial intelligence (AI) module 145. Communication module 123 includes program code that is executed by processor 102 to enable electronic device 100 to communicate with other external devices and systems. Artificial intelligence (AI) module 145 can be implemented as part of the codes of the DOV module 126 and can include program code that can be trained to perform different processes related to identifying discrepancies between images and recommending or suggesting actions to be performed to resolve the discrepancies between the images. The AI module 145 can retrieve images from the set of first images 128 taken when the items are packed for delivery and also retrieve images from the set of second images 129 taken when the items arrive at a destination location and perform comparisons to determine whether there are discrepancies between similar items and between the items as ordered and the items packed at the source and the items delivered at the destination location.

Although depicted as being separate from applications 125, CCM 124, DOV 126, the AI module 145 and communication module 123 may each be implemented as an application. Processor 102 loads and executes program code stored in system memory 120. Examples of program code that may be loaded and executed by processor 102 include program code associated with communication module 123 and applications 125 and program code associated with DOV 126. Execution of the code associated with DOV 126 causes the processor to access set of orders 335a, which are stored information about orders placed by the purchasers. The orders can be placed online by an order generator (purchaser) logging into an online order system associated with a seller/merchant/item supplier. The orders can also be placed using other ordering techniques including, for example, phone orders. The set of orders 335a can be used to identify items in an order placed by a purchaser and which are to be delivered to a delivery address (or destination location) specified within the order by the purchaser. Execution of the code associated with the delivery order verification module 126 can also cause the processor to access a first set of images 128 and a second set of images 129 to perform appropriate comparisons for delivery accuracy verification, using the AI module 145. The first set of images 128 can include images that are captured of the items in an order at a source location such as, for example, a warehouse where the items are stored and retrieved for delivery. The second set of images 129 can include images that are captured of the items in an order at a destination location such as, for example, a delivery address where the items are delivered by a delivery agent.

According to one or more embodiments, electronic device includes removable storage device (RSD) 105, which is inserted into an RSD interface (not shown) that is communicatively coupled via system interlink to processor 102. According to one or more embodiments, RSD 105 is a computer readable storage device encoded with program code and corresponding data, and RSD 105 can be interchangeably referred to as a non-transitory computer program product or non-transitory computer readable storage device having non-transitory computer readable program code/instructions. RSD 105 may have a version of DOV 126 stored thereon, in addition to other program code. Processor 102 can access RSD 105 to provision electronic device 100 with program code that, when executed by processor 102, the program code causes or configures electronic device 100 to provide the functionality described herein.

Display 130 can be one of a wide variety of display screens or devices, such as a liquid crystal display (LCD) and an organic light emitting diode (OLED) display. In some embodiments, display 130 can be a touch screen device that can receive user tactile/touch input. As a touch screen device, display 130 includes a tactile, touch screen interface 131 that allows a user to provide input to or to control electronic device 100 by touching features presented within/below the display screen. Tactile, touch screen interface 131 can be utilized as an input device.

Front facing cameras (or image capture device (ICD)) 132 are communicatively coupled to ICD controller 134, which is communicatively coupled to processor 102. ICD controller 134 supports the processing of signals from front facing cameras 132. Front facing cameras 132 can capture images that are within the field of view (FOV) of image capture device 132. Electronic device 100 includes several front facing cameras 132. First front facing camera 132A is a main camera that captures a standard angle FOV. Second front facing camera 132B is a wide angle camera that captures a wide angle FOV. Front facing cameras 132A and 132B can be collectively referred to as front facing cameras 132A-132B or simply front facing camera(s) 132. While two front facing cameras 132A-132B are shown, electronic device 100 can have more or less than two front facing cameras.

Electronic device 100 further includes several rear facing cameras 133. First rear facing camera 133A is a main camera that captures a standard angle FOV. Second rear facing camera 133B is a wide angle camera that captures a wide angle FOV. Third rear facing camera 133C is a telephoto ICD that captures a telephoto FOV (zoom or magnified). Each rear facing camera 133A, 133B, and 133C is communicatively coupled to ICD controller 134, which is communicatively coupled to processor 102. ICD controller 134 supports the processing of signals from rear facing cameras 133A, 133B and 133C. Rear facing cameras 133A, 133B and 133C can be collectively referred to as rear facing cameras 133A-133C or simply rear facing cameras 133. While three rear facing cameras are shown, electronic device 100 can have less than three rear facing cameras, such as having only one or two rear facing cameras, or can have more than three rear facing cameras. In one or more embodiments, one or more of the front facing cameras 132 and the rear facing cameras 133 can be used to capture images of the items of an order at a source location and at a delivery address (or destination location).

Electronic device 100 can further include data port 198, charging circuitry 135, and battery 143. Electronic device 100 further includes microphone 108, one or more output devices such as speakers 144, and one or more input buttons 107a-107n. Input buttons 107a-107n may provide controls for volume, power, and image capture device 132. Microphone 108 can also be referred to as audio input device 108. Microphone 108 and input buttons 107a-n can also be referred to generally as input devices.

Electronic device 100 further includes wireless communication subsystem (WCS) 142, which is coupled to antennas 148a-148n. According to one or more embodiments, WCS 142 can include a communication module with one or more baseband processors or digital signal processors, one or more modems, and a radio frequency (RF) front end having one or more transmitters and one or more receivers. Wireless communication subsystem (WCS) 142 and antennas 148a-148n allow electronic device 100 to communicate wirelessly with wireless network 150 via transmissions of communication signals 194 to and from network communication devices 152a-152n, such as base stations or cellular nodes, of wireless network 150. In one embodiment, network communication devices 152a-152n contain electronic communication equipment to allow communication with electronic device 100.

Wireless network 150 further allows electronic device 100 to wirelessly communicate with second electronic devices 192, which can be similarly connected to wireless network 150 via one of network communication devices 152a-n. Wireless network 150 is communicatively coupled to wireless fidelity (WiFi) router 196. Electronic device 100 can also communicate wirelessly with wireless network 150 via communication signals 197 transmitted by short range communication device(s) 164 to and from WiFi router 196, which is communicatively connected to network 150. According to one or more embodiments, wireless network 150 can include one or more servers 190 that support exchange of wireless data and video and other communication between electronic device 100 and second electronic device 192.

Electronic device 100 further includes short range communication device(s) 164. Short range communication device 164 is a low powered transceiver that can wirelessly communicate with other devices. Short range communication device 164 can include one or more of a variety of devices, such as a near field communication (NFC) device, a Bluetooth device, and/or a wireless fidelity (Wi-Fi) device. Short range communication device 164 can wirelessly communicate with WiFi router 196 via communication signals 197. In one embodiment, electronic device 100 can receive internet or Wi-Fi based calls via short range communication device 164. In one embodiment, electronic device 100 can communicate with WiFi router 196 wirelessly via short range communication device 164. In an embodiment, WCS 142, antennas 148a-n and short-range communication device(s) 164 collectively provide communication interface(s) of electronic device 100. These communication interfaces enable electronic device 100 to communicatively connect to at least one second electronic device 192 via at least one network.

Electronic device 100 further includes vibration device 146, fingerprint sensor 147, global positioning system (GPS) device 160, and motion sensor(s) 161. Vibration device 146 can cause electronic device 100 to vibrate or shake when activated. Vibration device 146 can be activated during an in-coming call or message in order to provide an alert or notification to a user of electronic device 100. In one embodiment, vibration device 146 is triggered to activate and vibrate the electronic device 100 in response to determining a discrepancy exists between the items presented on the order list and the first image or between the items presented within the first image and the second image. The vibration provides haptic feedback to indicate to the delivery agent or device user of the presence of the discrepancy, concurrently with presenting a visual notification and other selectable options on the display 130. According to one aspect of the disclosure, display 130, speakers 144, and vibration device 146 can generally and collectively be referred to as output devices.

Fingerprint sensor 147 can be used to provide biometric data to identify or authenticate a user. GPS device 160 can provide time data and location data about the physical location of electronic device 100 using geospatial input received from GPS satellites. GPS device 160 can be the location sensor that detects when electronic device 100 is in or near a delivery address, which the processor identifies as a destination location that requires or triggers the capturing of the second images of the items in the order being delivered to that address.

Motion sensor(s) 161 can include one or more accelerometers 162 and gyroscope 163. Motion sensor(s) 161 can detect movement of electronic device 100 and provide motion data to processor 102 indicating the spatial orientation and movement of electronic device 100. Accelerometers 162 measure linear acceleration of movement of electronic device 100 in multiple axes (X, Y and Z). For example, accelerometers 162 can include three accelerometers, where one accelerometer measures linear acceleration in the X axis, one accelerometer measures linear acceleration in the Y axis, and one accelerometer measures linear acceleration in the Z axis. Gyroscope 163 measures rotation or angular rotational velocity of electronic device 100. According to one or more embodiments, the measurements of these various sensors can also be utilized by processor 102 in the determining of the context of a communication. Electronic device 100 further includes housing 170 that contains/protects the components of electronic device 100.

In the description of each of the following figures, reference is also made to specific components illustrated within the preceding figure(s). Similar components are presented with the same reference number and some components may be provided with a subscripted reference number (e.g., 100a, 100b) to represent a same component/device being shown in a different context/configuration.

FIG. 1B depicts a functional block diagram of a second embodiment of a communication device, configured to operate as a network server and which facilitates verification of the accuracy of orders being delivered from a source location to a destination location, and within which the features of the present disclosure can be advantageously implemented. According to one aspect, communication device 100a verifies the accuracy of the order at one or both of the source location and the destination location. In one or more embodiments, communication device 100a can have similar or identical components to electronic device 100 (FIG. 1A), with certain components modified, added, or not included, as needed, for communication device 100a to function as a network server. In one or more embodiments, communication device 100a is configured as a network server having controller 110 that manages device memory 103, data storage subsystem 106, and network interface controller (NIC) 185.

Controller 110 manages, and in some instances directly controls, the various functions and/or operations of communication device 100a. These functions and/or operations include, but are not limited to including, application data processing, communication with second communication devices, navigation tasks, image processing, and signal processing. In one or more alternate embodiments, communication device 100a may use hardware component equivalents for application data processing and signal processing. For example, communication device 100a may use special purpose hardware, dedicated processors, general purpose computers, microprocessor-based computers, micro-controllers, optical computers, analog computers, dedicated processors and/or dedicated hard-wired logic.

Controller 110 includes processor subsystem 119, which includes one or more central processing units (CPUs), depicted as data processor 189. Processor subsystem 119 can include one or more digital signal processors 191 that are integrated with data processor 189 or are communicatively coupled to data processor 189. In one or embodiments that are not depicted, controller 110 can further include distributed processing and control components that are external to the communication device 100a. Data processor 189 is communicatively coupled, via system interlink 180, to device memory 103. In one or more embodiments, controller 110 of communication device 100a is communicatively coupled via system interlink 180 to data storage subsystem 106, and other subsystems (e.g., I/O subsystem, communication subsystem, etc.).

The processor subsystem 119 executes program code to provide operating functionality of communication device 100a. The software and/or firmware modules have varying functionality when their corresponding program code is executed by processor subsystem 119 or secondary processing devices within communication device 100a. Processor subsystem 119 of controller 110 can execute program code of the DOV 126a, the AI module 145a, and other applications 125a to configure communication device 100a to perform specific functions.

In one or more embodiments, communication device 100a has device memory 103, and data storage subsystem 106. Device memory 103 and the data storage subsystem 106 are managed by controller 110. Device memory 103 includes program code for applications, such as DOV 126a, AI module 145a, and other application(s) 125a. Device memory 103 further includes operating system (OS) 137, firmware interface 127, such as basic input/output system (BIOS) or Uniform Extensible Firmware Interface (UEFI), and firmware 111. Device memory 103 can include the set of first images 128a and the set of second images 129a used by DOV 126a and AI module 145a. As an example, applications such as the AI module 145a can analyze one or more images of the set of first images 128a to identify items that have been included in a container that is to be delivered to a destination location.

Data storage subsystem 106 of communication device 100a includes data storage device(s) 179 and RSD 101. Controller 110 is communicatively connected, via system interlink 180, to data storage device(s) 179 and RSD 101 (via RSD interface 182). In one or more embodiments, data storage device(s) 179 can include hard disk drives (HDDs), optical disk drives, and/or solid-state drives (SSDs), etc. In one or more embodiments, RSD 101 is a non-transitory computer program product or computer readable storage device. Controller 110 can access RSD 101 or data storage device(s) 179 to provision communication device 100a with program code, such as code for the DOV 126a, AI module 145a, and other application(s) 125b. These applications can be loaded into device memory 103 for execution by controller 110. When executed by controller 110, the program code causes or configures communication device 100a to facilitate the delivery of orders placed by a purchaser/order generator.

The network interface controller (NIC) 185 is connected with a network connection (NC) 186. In one embodiment, NC 186 can be an Ethernet connection. Network cable 187 connects NC 186 to network 188. NIC 185 can be referred to as a “network interface” that can support one or more network communication protocols. Network 188 can be a local area network (LAN), a campus area network (CAN), a metropolitan area network (MAN), or a wide area network (WAN). Second communication devices 136 is shown communicatively coupled to network 188. Communication device 100a is communicatively connected with communication/electronic device 100 via network 188. Connection 195 from the communication device 100a to the network 188 can be a wired connection or a wireless connection.

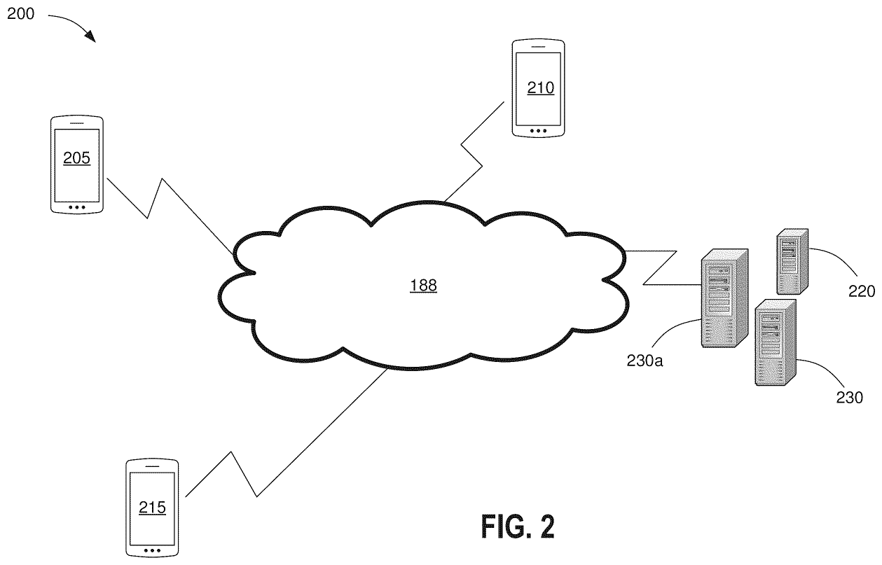

FIG. 2 depicts an example network environment 200 within which different electronic devices of different delivery agents can be connected to communication network 188 in order to access information about orders placed with one or more sellers/suppliers/merchants via an order system implemented in a network-accessible computing system that provides an order receiving server 220, according to one or more embodiments. In addition to order receiving server 220, the network-accessible computing system can include a delivery order verification (DOV) server 230. DOV server 230 can be the same server (system) as order receiving server 220 that implements DOV code to track and manage the deliveries of orders. Each of the electronic devices 205-215 can be an implementation of or similar to electronic device 100 depicted in FIG. 1A. Order receiving server 220 and DOV server 230 can be a computing system or distributed computer system. The DOV server 230 can include more than one computer system (e.g., DOV server 230 and DOV server 232) that supports one or more sellers/suppliers/merchants who provide items that can be selectively placed on an order by a purchaser/order generator.

The order generator can then apply payment for the items, which triggers DOV server 230 to send the order for filling/completing at a specific source location (e.g., the grocery store's delivery/packing department/group). A delivery agent can use another electronic device, such as electronic device 205, to retrieve information about an order placed by a purchaser. The information about an order can include at least a delivery address and identification of items to be delivered. The items of an order can be packed at a source location (e.g., a warehouse) by a packing agent for delivery by the delivery agent. Alternatively, the items can also be packed by the delivery agent. The DOV server 230 can be located at the source location or at a data center, located remotely from the source location.

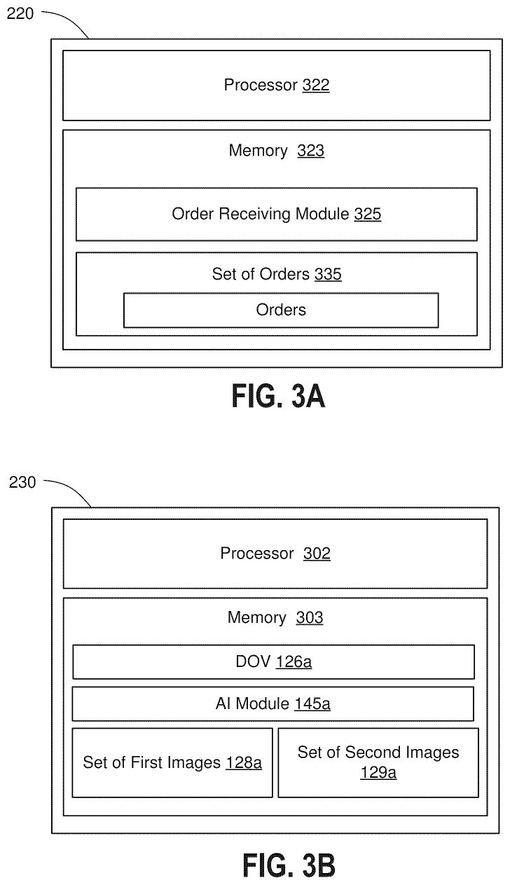

FIG. 3A depicts an example order receiving server 220 that can be implemented to enable receiving orders placed by purchasers or an order generator for delivery to a destination location, according to one or more embodiments. The order receiving server 220 can include a processor 322 and memory 323. The processor 322 can execute codes of the order receiving module 325 to enable one or more sellers/suppliers/merchants to offer items to be purchased/ordered and to receive orders from the purchasers or from the order generator.

The order generator can use an electronic device, such as the electronic device 210 (FIG. 2), to select the items for delivery and thus generate the order. As an example, the order generator may access a website or shopping portal of a merchant, such as a grocery store, and place specific items in a shopping cart, and also select the delivery option as the method of obtaining the items. In one or more embodiments, the website or shopping portal can be implemented by executing codes of the order receiving module 325. The orders received from the purchasers/order generator can then be stored in the set of orders 335, which can be stored in memory 323 and/or a storage device associated with the order receiving server 220

The set of orders 335 can include individual orders received from the purchasers/order generator. In one or more embodiments, the set of orders 335 can include orders received on behalf of different sellers/merchants. In one or more embodiments, when the order receiving server 220 is capable of supporting multiple sellers/merchants, an order in the set of orders 335 can include at least a seller/merchant identification, an order number, a delivery address, and information about items included in the order. In one or more embodiments, a delivery agent can use an electronic device (e.g., electronic device 205) to retrieve an order via the communication module 123 (FIG. 1A) from the set of orders 335 of the order receiving server 220. The retrieved order can be stored in the set of orders 335a (FIG. 1A) of the delivery agent's electronic device.

FIG. 3B depicts an example delivery order verification server 230 that can be implemented to enable a server-based processing of orders received by the order receiving server 220, including the delivery of items in orders from a source location to a destination location, according to one or more embodiments. The DOV server 230 can include features similar to the features described with the communication server 100a (FIG. 1B). The DOV server 230 can include memory 303, and one or more processors 302 configured to execute codes to enable the one or more sellers/suppliers/merchants to facilitate delivery of orders by delivery agents. The one or more images of the set of first images 128 (FIG. 1A) are also stored in the delivery order verification server 230 as the set of first images 128a. Similarly, the one or more images of the set of second images 129 are also stored in the delivery order verification server 230 as the set of second images 129a.

In one or more embodiments, the operations of the delivery order verification server 230 are implemented when similar verifications are not performed by the electronic device (e.g., electronic device 100) of the delivery agent, so as to avoid duplication. For example, instead of the processor 102 of electronic device 100 executing codes of the DOV 126 and the AI module 145 to verify the accuracy of the delivery of the order, the processor 302 of the delivery order verification server 230 executes codes of the DOV 126a and the AI module 145a to verify the accuracy of the delivery of orders. The operation of the DOV 126a and the AI module 145a can be triggered based on receiving one or more second images in the set of second images 129a along with an indication of a specific delivery order for which the second images were captured for order delivery verification.

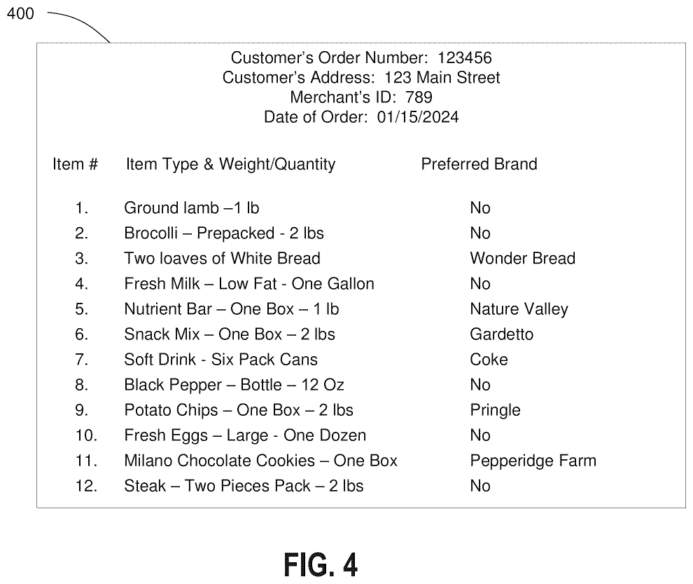

FIG. 4 depicts an example order of items for delivery, which includes identification of the items ordered, a delivery address, and an identification of the sourcing entity/location, according to one or more embodiments. The order 400 can be assigned an order number (e.g., order #123456), a delivery address (e.g., 123 Main Street), and an order date (e.g., Jan. 15, 2024). In embodiments where the order receiving server 220 supports more than one seller/merchant, the order 400 also includes the merchant's identification (e.g., merchant #789). Each item in the order 400 can be associated with an item number and a description. The description can include information that describes an item type. In some embodiments, the description can also include information that describes the item brand and related size such as quantity and/or weight. For example, in the order 400, there are twelve unique items numbering 1-12, where the item number 3 refers to white bread as the item type with the quantity of two (2) loaves and with the preferred brand as Wonder Bread. Although the items shown in the order 400 include consumable items (e.g., grocery items), it is understood by those skilled in the art that the order can include non-consumable items such as, for example, a household plant, a bar stool, or a television set. Order 400 can be stored in the set of orders 335a (FIG. 1A) and accessed using the order number or delivery name and/or address or other unique identifying detail. Order 400 can also be saved in the set of orders 335 in the order receiving server 220.

In one or more embodiments, the order (e.g., order 400) can be used to identify the items to be packed by a delivery agent or a packing agent for delivery to the indicated destination location. In one or more embodiments, the order can be used to verify whether the items packed at the source location for delivery accurately reflect the items that the order generator included in the order when the order was placed as a pre-delivery check. The order can also be used to verify whether the items delivered at the destination location accurately reflect the items originally ordered as a post-delivery check.

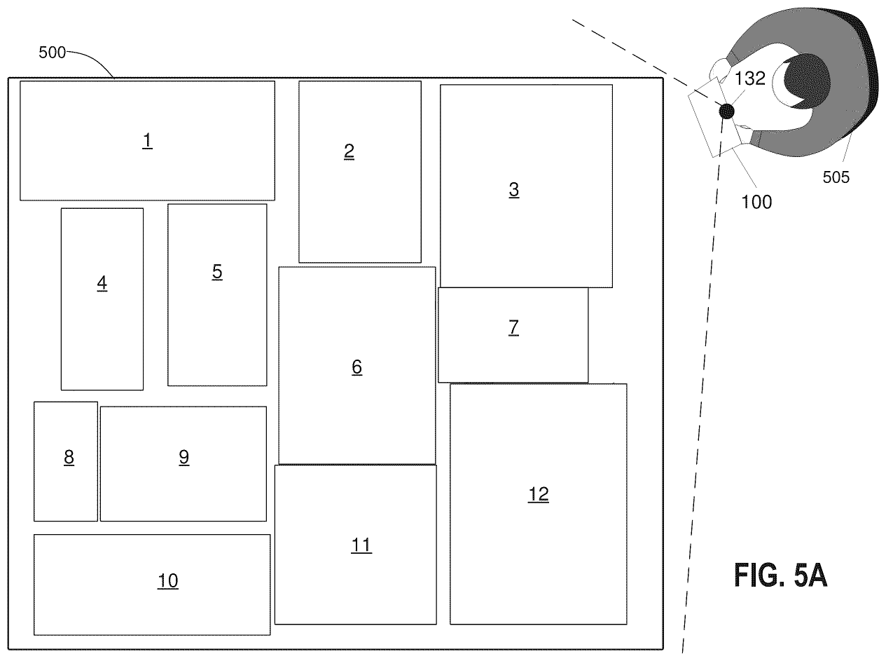

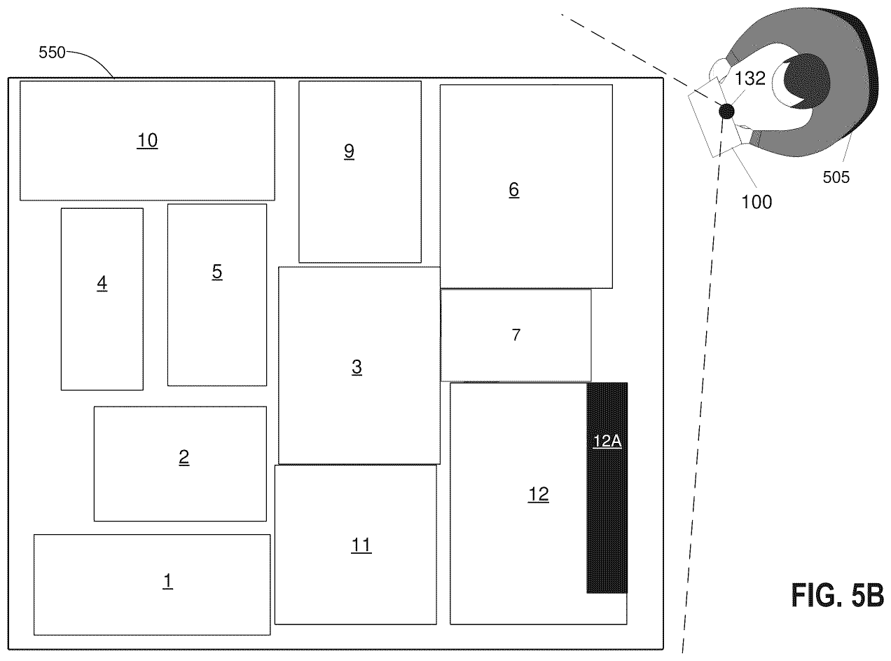

FIG. 5A depicts capturing of a first image of an example original packing container 500 within which different items of an order are placed at a source location to be delivered by a delivery agent to a destination location specified by the originator of the order, according to one or more embodiments. It is appreciated that the delivery agent can be an employee or contractor who works for the supplier of the items; However, the delivery agent can also be an independent delivery person who is contracted to deliver specific orders assigned to that delivery agent. The items shown in the original packing container 500 correspond to the items shown in the order 400 of FIG. 4 with the corresponding items having similar item numbers. In one or more embodiments, upon completion of finding or locating the items at a source location to fulfill the order 400, a first image is captured of all the items in the original packing container 500 with each item arranged in a manner where each can be identified from the first image. For example, the items can be arranged adjacent to one another with minimal or no overlapping of one another, as shown in FIG. 5A. In one or more embodiments, multiple first images may be captured of the items to improve identification. For example, each of the multiple first images can be captured from a different angle so that an item that is not clearly identifiable in one first image can be more clearly identifiable in another first image.

In one or more embodiments, the one or more first images is captured by the delivery agent 505 (or by the packing agent 506) at the source location using one or more cameras (e.g., front camera 132) associated with the ICD controller 134 of the electronic device 100 (FIG. 1A). In FIG. 5A, the delivery agent 505 is depicted to be the person that captures the one or more first images. The one or more first images can be associated with an order based on the order number such as, for example, order #123456 (FIG. 4). The one or more first images can be stored in the set of first images 128 of the electronic device 100. Alternatively, or in addition, the one or more first images can be stored in the DOV server 230 (FIG. 2) or a connected storage repository. For example, when the one or more first images is captured by a camera associated with the ICD 134, the one or more first images can be transmitted by the electronic device 100 via network 188 to the DOV server 230.

According to one or more embodiments, following the capturing of the first image, the electronic device 100 or the DOV servicer 230 performs an order verification process for a pre-delivery check that includes: comparing, using artificial intelligence with image analysis features and a database of images and item names, the list of items in the order 400 (FIG. 4) with the items captured in the first image; and confirming that the captured first image includes all of the items on the order's list of items (400). The order verification process includes, in response to the captured items matching a full complement of the list of items, presenting and storing a confirmation of the pickup of the order being complete. Also, in response to not having a match of the full complement of the list of items, the order verification process includes presenting and storing a notification of the items of the order 400 that are missing from the items presented in the captured image. The method then includes generating and outputting a prompt on the local user electronic device 100 for the person to search for and add the missing items into the packing container and then retake the first image at the source location. The prompt may also enable the user to indicate that the particular item is not available and whether a refund or a later delivery is to be provided for that item.

FIG. 5B depicts capturing of a second image of an example delivered packing container 500a of the ordered items at a destination location, while the delivered packing container 500a is still in the possession of the delivery agent and with specific items missing, according to one or more embodiments. In ideal situations, the contents of the packing container at the delivery location (which is referenced hereafter as the delivered packing container 500a) should be similar to the contents of the original packing container 500. Also, the content of the delivered packing container 500a should also include all the items that the purchaser/order generator included in the order 400 (FIG. 4) and the delivered items should be in the condition that would be expected by the purchaser or the recipient of the order.

In one or more embodiments, the processor monitors/tracks the location of the electronic device relative to the source location and the destination location to identify when the electronic device is at either location. The location monitoring/tracking can involve use of the built-in GPS device 160 or other location sensor or methodology available to the electronic device 100 (e.g., cellular tower triangulation, WiFi signal localization, etc.). When the delivered packing container 500a reaches the destination location (e.g., based on the delivery address and the device location information provided by the GPS 160), the delivery agent 505 (assuming it is the same agent as depicted in FIG. 5A) is prompted, by a processor-generated or processor-surfaced notification on his electronic device, to use the camera 132 of the electronic 100 to capture a second image of all the items in the delivered packing container 500a. In the situation where not all of the items in the delivered packing container 500a are visible (e.g., due to one or more items overlapping), the items in the delivered packing container 500a can be re-arranged by the delivery agent 505 in a manner such that all items can be identified from the second image. For example, the items can be arranged adjacent to one another with minimal or no overlapping of one another, as shown in FIG. 5B. In one or more embodiments, the second image of the items is captured before the items are arranged, and then a third image of the items can be captured after the arrangement. A prompt for the delivery agent to recapture the image and or re-arrange the items prior to capturing or recapturing the image can be generated by the AI recognizing that the pre-image or captured image does not clearly present each of the items for identification. Once this deficiency is identified, the AI may prompt the recapture of the entire set of items or of specific areas of the packing container or of a different angle of the item(s) in order to identify the items not initially visible by the pre-image or captured image. In one or more embodiments, arrows and/or other visual cues can be presented (by the processor or AI) on the image or pre-image to assist the delivery agent with identifying which item(s) cannot be clearly identified within the pre-image/image. The prompt to capture a third image (or subsequent images as needed) is presented to the display of the electronic device 100 and can also be presented audibly via the speakers of the electronic device 100. Other means of notifying the delivery agent of the requirement to recapture the image or reposition the items can be provided in other embodiments. In such situations, the third image can be used by the AI module 145 to identify the items at the destination location.

In one or more embodiments, multiple second images may be captured of the items to improve identification. For example, each of the multiple second images can be captured from a different angle so that an item that is not clearly identifiable in one second image can be more clearly identifiable in another second image. The one or more second images can be associated with an order based on the order number such as, for example, order #123456 (FIG. 4).

The one or more second images can be stored in the set of second images 129 of the electronic device 100. Alternatively, or in addition, the one or more second images can be stored in the server computing system 230 (FIG. 2). For example, when the one or more second images is/are captured by a camera 132 associated with the ICD 134, the one or more first images as well as the one or more second images can be transmitted by the electronic device 100 to the DOV server 230 for matching analysis by a server-based AI module 145a. In one or more embodiments, the operation of the AI module 145 (FIG. 1A) or server-based AI module 145a can be triggered based on, or in response to, detecting the capturing of the one or more second images at the destination location. The AI module 145 or server-based AI module 145a can autonomously match the one or more second images stored in the set of second images 129 (or the server-based set of second images 129a) with the one or more first images stored in the set of first images 128 (or the server-based set of first images 128a) based on their associated order number.

In one or more embodiments, the AI module 145 can perform operations to match an item included within the original packing container 500 with an item delivered within the delivered packing container 500a even though the delivered item may be displaced to a different position within the delivered packing container 500a. For example, referring to FIGS. 5A and 5B, the items 2 and 9 in the original packing container 500 (FIG. 5A) are displaced within the delivered packing container 500a in FIG. 5B. Similarly, items 3 and 6 are displaced. For one or more embodiments, the AI module 145 can perform matching operations based on physical attributes of an item, color attributes of the item, and textual and image attributes. As examples, the physical attributes can include geometrical shape, thickness, size and weight. The color attributes can include the color of the item, the packaging, and/or the color of its content, and the textual and image attributes can include product name, textual description, and images and logos detected on the item. As specific examples, item 4 of order 400 (FIG. 4) can be recognized based on its size attribute of being one gallon and based on its content being milk. As another example, item 9 of order 400 can be recognized based on its shape being tubular and based on its brand being “Pringle.”

It is possible that during the delivery process, one or more items included in an order can be accidentally damaged such that the item's condition at the delivery location may be different from its condition at the source location, and not acceptable for delivery to the recipient. In onc or more embodiments, the AI module 145 or the server-based AI module 145a can perform operations to evaluate the condition of each item or of specific perishable items, based on the one or more first images and the one or more second images, to determine whether there are differences in the condition of the delivered items. When a difference is detected, the AI module 145 or the server-based AI module 145a can evaluate the difference to determine whether the difference can be categorized as a material discrepancy or a non-material discrepancy. A material discrepancy can be flagged for an item when the condition of the item is determined by the AI module 145 to be unacceptable to the purchaser or the recipient of the order. Such condition can occur, for example, when one or more items in the original order is found to be broken/damaged, to have incorrect brand/type/weight, or to be missing from the packing container at the destination location. A non-material discrepancy can be determined by the AI module 145 when the condition of an item may be acceptable by the purchaser or the recipient of the order even though a difference is detected from the condition of the same item at the source location. Such a condition can occur, for example, when one or more items in the original order is determined by the AI module 145 to have a slight variation in its packaging that does not affect its content. For example, referring to FIG. 5B, item 112 is shown to include a damaged area 112A. When the AI module 145 or the server-based AI module 145a determines that the damaged area 112A is a material discrepancy, the AI module 145 or the server-based AI module 145a can flag the specific item as being defective and/or flag the delivery as being partially defective, and AI module 145 or the server-based AI module 145a can generate corrective actions and communicate the corrective actions to the delivery agent 505. Communicating the corrective actions and/or other information to the delivery agent 505 can include presenting textual information on the display 130 of the electronic device 100 and/or causing an audible sound wave to be sent to the speaker 144 of the electronic device 100. When the difference is categorized as a non-material discrepancy (e.g., minor damage), the difference is deemed by the AI module 145 or the server-based AI module 145a to not be sufficient to flag the delivery as defective. However, the detected/identified difference can be flagged and stored for later access.

In one or more embodiments, the AI module 145 or the server-based AI module 145a can perform operations to determine whether an item included in the original packing container 500 is missing from the delivered packing container 500a. The AI module 145 or the server-based AI module 145a can identify the missing item based on comparing the one or more first images and the one or more second images. The missing item can be displaced from the delivered packing container 500a intentionally or accidentally due to, for example, theft or breakage of the delivered packing container 500a. Referring to FIG. 5A, item 108 is shown to be included in the original packing container 500 but is determined to be missing from the delivered packing container 500a of FIG. 5B. In one or more embodiments, a material discrepancy exists when the AI module 145 or the server-based AI module 145a determines that an item included in the original packing container 500 is missing from the delivered packing container 500a. The delivery can then be flagged by the AI module 145 or the server-based AI module 145a as being defective. The AI module 145 or the server-based AI module 145a can then generate corrective actions and communicate the corrective actions to the delivery agent 505. Possible corrective actions that can be surfaced include refunding the cost of the items to the original payment mechanism (assuming payment was made for the items), requiring the delivery agent to advise the recipient of the missing items, and requiring the delivery agent to return to the source and obtain additional replacement items for delivery to the recipient.

In one or more embodiments, the AI module 145 or the server-based AI module 145a can also perform operations to identify items that are similar in type even though the items may be associated with different brands. For example, a six-pack of Coke cans can be identified by the AI module 145 to be of the same type as a six-pack of Pepsi cans. For example, item 7 is shown in order 400 as a six-pack of Coke, but the original packing container 500 shows, based on the analysis of the AI module 145 or the server-based AI module 145a, that item 7 is instead a six-pack of Pepsi. The fulfillment of an item of a different brand can be accidental and can be caused by an oversight at the source location. This can be determined as a material discrepancy especially because the purchaser has specifically identified the preferred brand. It is possible that the item of the preferred brand is not in stock, and the delivery agent 505 or the packing agent 506 at the source location can intentionally fill the order using an item of a different brand as a suggestion. Alternatively, the item can be left out of the delivery as being unfulfilled. The AI module 145 can flag the delivery as being defective, and it can generate corrective actions and communicate the corrective actions to the delivery agent 505. It may be noted that some of the items in the order 400 do not indicate a preferred brand. In these situations, the AI module 145 can bypass the brand recognition operation for these items and pass the delivered items as complete regardless of the brand of the item that is included in the order.

In one or more embodiments, the AI module 145 can perform operations to determine whether the items included in the delivered packing container 500a correspond to the items included in the order 400 (FIG. 4) as a post-delivery check. The AI module 145 can perform operations to identify the items captured in the one or more second images or stored in the set of second images 129 and compare those items with the items included in the order 400. Ideally, the items should match. However, when a seller runs out of stock of an item that the purchaser places in the order 400, that item cannot be fulfilled and therefore cannot be included in the original packing container 500 at the source location. The issue can be categorized as a material discrepancy. Thus, even when the AI module 145 matches all the items in the one or more first images and in the one or more second images, the AI module 145 can flag the delivery as being defective, and it can generate corrective actions and communicate the corrective actions to the delivery agent 505. Notable, in one embodiment, the processor can generate a selectable option for the recipient to indicate if the alternate item is acceptable, such that the order/item is not flagged as defective, or the defective notification is overridden with the end customer's approval.

In one or more embodiments, the AI module 145 can perform operations to determine whether the items included in the delivered packing container 500a correspond to the items included in the order 400 (FIG. 4) according to the description provided by the purchaser. For example, referring to the item 1 of the order 400 which specifies one pound of lamb, in addition to identifying the item 1 in the one or more second images and matching item 1 with order 400, the AI module 145 can perform operations to determine whether the quantity of the item delivered is one pound and is thus accurate. As another example, referring to item 4 of order 400 which specifies one gallon of low-fat milk, the AI module 145 can detect (e.g., based on the bottle labeling) whether item 4 included in the original packing container 500 or the delivered packing container 500a reflects low fat milk and not any other type of milk. When the quantity and/or type associated with an item in the delivered packing container 500a is different from the quantity specified in the order 400, the difference can be categorized as a material discrepancy. As such, the AI module 145 can flag the delivery as being defective, and the AI module 145 can generate corrective actions and communicate the corrective actions to the delivery agent 505.

The AI module 145 can perform operations to identify the items captured in the one or more second images stored in the set of second images 129 and compare those items with the items included in the order 400. When there is an item identified in the one or more second images and not included in the order 400, the item is flagged as an item that was not to be included in the delivered order and was probably added to the original packing container 500 by accident. This can be categorized as a non-material discrepancy, and when there is no other defect, the delivery can be finalized at the destination location. In one or more embodiments, the AI module 145 can generate notification to instruct the delivery agent 505 to communicate the non-material discrepancy to a recipient at the destination location. Alternatively, the AI module 415 can generate a notification instructing the delivery agent to remove the additional item from the delivered items.

In one or more embodiments, the AI module 145 can present a prompt to the delivery agent 505 requesting input of information related to a cause for each of the identified at least one material discrepancy. For example, the delivery agent 505 can indicate that an item in the delivered packing container 500a is damaged because the delivered packing container 500a was dropped during transportation.

In one or more embodiments, the corrective actions communicated by the AI module 145 can include one or more of the following: (i) providing an on-location explanation of why the one or more material discrepancies exist; (ii) informing the purchaser and/or recipient of the one or more material discrepancies; (iii) enabling a purchaser to request a refund for one or more items confirmed to be missing from the delivered at least one item or damaged; (iv) enabling the purchaser to accept the delivery of the order as completed with no further action by the delivery agent; and (v) requesting the delivery agent return to the source to retrieve and deliver one or more items confirmed to be missing from the delivered at least one item.

In one or more alternate embodiments, the features described herein including the features of the AI module 145 can be implemented at the DOV server 230 of FIG. 2 and FIG. 3B that is supporting the order verification, instead of being performed locally at the individual electronic device (e.g., the delivery agent's electronic device 100) at which the delivery order verification module 126 operates (i.e., is being locally executed). With these embodiments, the one or more first images and the one or more second images captured by the electronic device 100 are transmitted to the DOV server 230 and saved in a storage device associated with the DOV server 230. Further, server implementations of the delivery order verification module 126 and the AI module 145 of electronic device 100 can also be incorporated within the DOV server 230 as delivery order verification module 126a and the AI module 145a.

In one or more embodiments, based on receiving the one or more second images associated with an order, the DOV server 230 then utilizes the AI module 145a to analyze the one or more first images of the set of first images 128a and the one or more second images of the set of second images 129a to identify items in the original packing container 500 (FIG. 5A) and in the delivered packing container 500a (FIG. 5B) to detect/determine similar items, damaged/defective items, and/or missing items. Depending on the result of the analysis performed by the AI module 145a, one or more corrective actions can be generated to enable completion of the delivery.

In one or more embodiments, the DOV server 230 can be implemented as part of a data processing system which includes a memory having a delivery order verification (DOV) module 126a for verifying items delivered (see FIG. 3B). The data processing system can include a processor communicatively coupled to the memory and which executes program code for the delivery order verification module 126a which configures the processor to: (i) receive a first order of a purchaser, the first order specifying at least one item ordered by the purchaser to be delivered from a source location to an address associated with the first order; (ii) receive a first image comprising the at least one item provided at the source location for delivery to a recipient address to complete the first order; (iii) subsequently receive a second image comprising at least one item that was delivered at the address during completion of the first order; (iv) individually identify and compare each of the at least one item in the first image with the delivered at least one item in the second image; and (v) in response to identifying one or more material discrepancies between the at least one item in the first image and the delivered at least one item in the second image, generate at least one notification specifying the identified one or more material discrepancies.

In one or more embodiments, following the capturing of the first image, the processor of the data processing system executes program code for the delivery order verification module 126a which configures the processor to perform a pre-delivery check that includes: comparing, using artificial intelligence with image analysis features and a database of images and item names, the list of items of the order (e.g. order 400) with the items captured in the first image; and confirming that the captured first image includes all of the items on the order's list of items. The order verification process includes, in response to the captured items matching a full complement of the list of items, presenting and storing a confirmation of the pickup order being complete. Also, in response to not having a match of the full complement of the list of items, the order verification process includes presenting and storing a notification of the items that are missing from the captured items. The order verification process can include generating and outputting a prompt on the local user electronic device of the delivery agent 505 or the packing agent 506 at the source to search for and add the missing items into the packing container and the retake the first image at the source location. The prompt may also enable the delivery agent 505 or the packing agent 506 to indicate that the particular item is not available and whether a refund or a later delivery is to be provided for that item.

In one or more embodiments, the data processing system can also include a communication subsystem that enables an electronic device (e.g., the electronic device 100) to connect (i) to an ordering system (e.g., order receiving server 220) to receive information about the at least one item included in the first order for delivery from the source location to the address associated with the first order; and (ii) to a communication network via which one or more mobile communication devices (e.g., electronic device 100) connect to provide the first image and the second image and receive the at least one notification. The data processing system is a delivery order verification system, and the processor (i) receives a first identification of a first delivery agent assigned to complete the delivery of a first order, the first delivery agent having a corresponding first mobile communication device, with first device identifier, e.g., a phone number; (ii) receives the first image from a location of the source location prior to the first order leaving the source location; (iii) associates, within a delivery database, the first delivery agent with the first order and the first image; (iv) subsequently receives a confirmation of delivery message with the second image from the first mobile communication device. In response to receiving a confirmation of delivery message with the second image from the first mobile communication device (i) initiates, via an artificial intelligence (AI), the identify and compare processes to determine whether the one or more material discrepancies exists between the items delivered and the items initially provided at the source location; and (ii) in response to identifying the one or more material discrepancies, transmits, via the communication system, the notification to the first mobile communication device, the notification including: a description of the one or more discrepancies; and at least one indication of at least one corrective action required to be taken.

In one or more embodiments, the at least one corrective action includes at least one of the following: (i) re-positioning the delivered at least one item in the second image and capturing and transmitting at least one third image of the repositioned at least one item; (ii) providing an on-location explanation of why the one or more discrepancies exist; (iii) informing the purchaser of the one or more discrepancies; (iv) enabling the purchaser to request a refund for one or more items confirmed to be missing from the delivered at least one item; (v) enabling the purchaser to accept the delivery of the order as completed with no further action by the delivery agent; and (vi) requiring the delivery agent to return to the source location to retrieve and deliver one or more items confirmed to be missing from the delivered at least one item.

In one or more embodiments, for each of the one or more material discrepancies, the processor determines a discrepancy type, and presents, within the notification, corresponding detail of the discrepancy type associated with each of the one or more material discrepancies. The processor can update a record in the delivery database indicating the at least one material discrepancy and generate and provide a report of the at least one material discrepancy to the computer of the seller/merchant/source associated with the order.

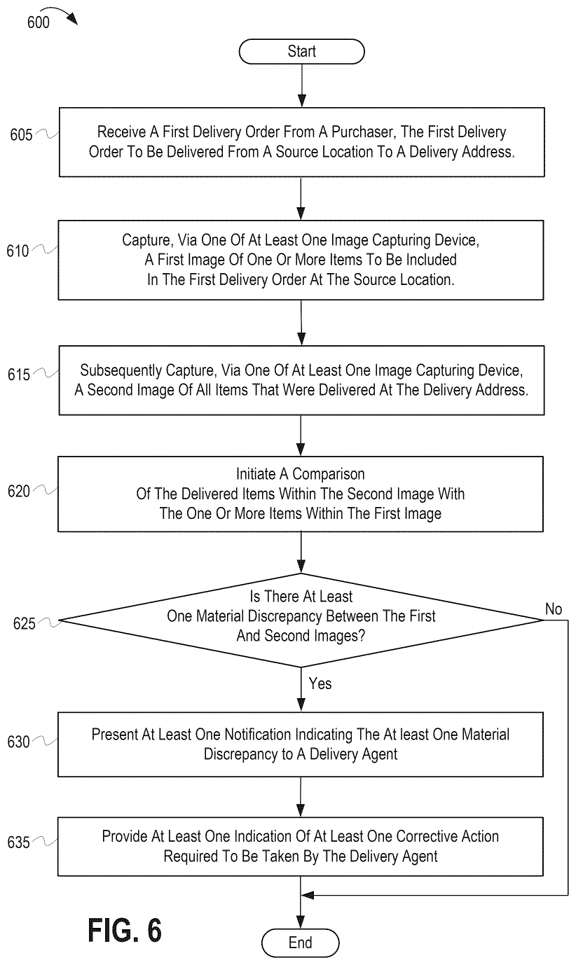

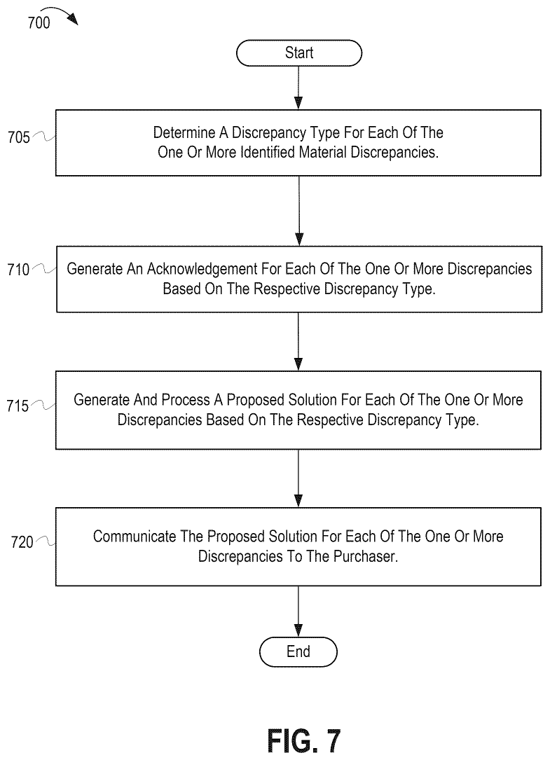

FIGS. 6-7 depict flow diagrams of different methods for performing order verification based on analyzing images captured of the items in the order at the source locations and images captured of the items in the order at the destination locations, according to respective embodiments. In at least one embodiment, the electronic device 100 is controlled by processor 102, which executes code of the delivery order verification (DOV) module 126 (FIG. 1A) and the AI module 145 to enable the electronic device 100 to perform the functionality described for method 600 (FIG. 6), as well as method 700 (FIG. 7) in order to identify and trigger responses to any potential material discrepancies associated with the delivery of the orders.

The description of methods 600/700 is provided with general reference to the specific components illustrated within the preceding FIGS. 1-5B, and specific components referenced in methods 600/700 may be identical or similar to components of the same name used in describing preceding FIGS. 1-5B.

FIG. 6 depicts a process for determining discrepancies in an order when the order is delivered from a source location to a destination location and identifying corrective actions to be performed when one or more discrepancies are determined in the order, according to one or more embodiments. The method 600 can be performed using electronic device 100 operated by a delivery agent 505 (FIG. 5A and FIG. 5B) to capture images of the items in the order. The method 600 can use the order example shown in FIG. 4 where a list of items in the order can be used to confirm the items included in the delivery from the source location to the destination location. The method 600 starts at block 605 where an order (e.g., order 400) is received from a purchaser/order generator. The order is requested from and/or is to be delivered from a source location to a destination location (or a delivery address). The order can be placed using any ordering method (e.g., by phone, online, in-person). An order (e.g., order 400 of FIG. 4) can be received by the order receiving module 325 (FIG. 3A).

In one or more embodiments, the order can be fulfilled at a source location (e.g., a warehouse) by a delivery agent 505. At block 610, the delivery agent 505 captures, via one of at least one image capturing device of the electronic device 100, a first image of one or more items to be included in the order at the source location. An example of a person capturing the first image of the items in an order is shown in FIG. 5A. Multiple different images can be captured from different angles or positions to ensure all of the items that are being packed within the order can be individually identified. The first image can be stored in the set of first images 128 of the electronic device 100. In the embodiments that include use of the DOV server 230, the set of first images 128 are also transmitted to the DOV server 230 for storage using the order ID and delivery name and address to tag or associate the set of first images 128. The packed item(s) for the order is/are then transported to the destination location by the delivery agent.

At block 615, when the order is delivered at the destination location, the processor senses the device location corresponds to the delivery address and generates a prompt for the delivery agent to capture a second image of the delivered order. The second image of one or more items included in the order is captured by the delivery agent 505 using one of the at least one image capturing device and the second image is received by the processor. The method can include prompting for the capture of multiple second images from different angles or positions to ensure all of the items can be identified. The second image can be stored in the set of second images 129 of the electronic device 100. In the embodiments that include use of the DOV server 230, the set of second images 128 are also transmitted to the DOV server 230 for storage using the order ID and delivery name and address to tag or associate the set of second images 128.

In one or more embodiments, the capturing and storing of the second image can automatically trigger operations of the AI module 145 of the electronic device 100. At block 620, the AI module 145 can analyze the first image(s) and the second image(s) associated with the order, identify the one or more items within the first image and within the second image, and initiate a comparison of the one or more identified items within the first image and within the second image. The comparison can be used to identify one or more discrepancies. A discrepancy can be a material discrepancy or non-material discrepancy.

At block 625, a determination is made whether there is there is one or more material discrepancies with the items in the order. In response to there being one or more material discrepancies with the items in the order, the AI module 145 generates and presents at least one notification, as shown in block 630. The notification can include information describing the appropriate discrepancy type and can be communicated to delivery agent 505. At block 635, the AI module 145 provides at least one indication of at least one corrective action to be performed by the delivery agent 505. The at least one corrective action can then be communicated to the delivery agent 505. One example of corrective action can include indicating to the purchaser or the recipient of the order that there is one or more discrepancies in the delivery. Another example of corrective action can include providing options to the purchaser or the recipient of the order to resolve the material discrepancy. From block 625, when no material discrepancy is identified in the items within the order at the destination location, the delivery of the order is completed.

FIG. 7 depicts a process of determining the discrepancy type associated with each identified discrepancy and generating possible corrective actions according to the discrepancy type to complete a delivery of an order, according to one or more embodiments. The method 700 can be performed using the operations of the AI module 145 of the electronic device 100. The method 700 starts with the AI module 145 having already determined that one or more discrepancies exist with the items included in the delivered packing container 500a (FIG. 5B). The method 700 starts at block 705 where a discrepancy type is determined for each of the one or more identified material discrepancies. Examples of discrepancy types include missing item, damaged item, item with an incorrect brand, item with an incorrect type or quantity, and item not ordered but mistakenly included in the order, etc. At block 710, the AI module 145 generates an acknowledgement for each of the one or more discrepancies based on the respective discrepancy type. The acknowledgement is communicated to the delivery agent 505 to enable the delivery agent 505 to be aware of the specific discrepancy in the items identified by the AI module 145. For example, the delivery agent 505 can proactively examine the identified items and show them to the recipient of the order at the destination location. At block 715, the AI module 145 can generate and process a proposed solution for each of the one or more discrepancies based on the respective discrepancy type. For example, when the AI module 145 determines that the item 8 is missing from the delivered packing container 500a, the AI module 145 can generate a refund proposed solution to reimburse the purchaser for the missing item 8. Similarly, when the AI module 145 determines that the item 112 in the delivered packing container 500a is damaged, the AI module 145 can generate a proposed replacement solution to the purchaser such that the delivery agent 505 can deliver a replacement item 112 in a subsequent delivery. At block 720, the AI module 145 can communicate the proposed solution for each of the one or more discrepancies to the recipient (or the purchaser) of the order. When the proposed solution to the affected items is accepted by the recipient/purchaser of the order, the order can be considered as completed even though the processing of the proposed solution(s) is still active and/or pending completion. Alternatively, the order can be marked as completed when the processing of the proposed solution(s) is completed.

According to one or more embodiments, one or more of methods 600/700 further include the processor executing code to: (i) transmit, via the communication subsystem, the first image and the second image to a delivery order verification system, which performs image comparison via an artificial intelligence (AI) to identify items and characteristics of items within an order and determine when the at least one material discrepancy exists that warrants the at least one notification to the delivery agent; and (ii) receive the notification from the delivery order verification system, the notification including a description of the at least one material discrepancy and the least one indication of the least one corrective action required to be taken by the delivery agent in response to the material discrepancy in order to address the material discrepancy.

One or more of the methods 600/700 further includes the processor executing code to, in response to a presence of multiple different discrepancy types between the one or more items captured in first image and the delivered items captured in the second image: (i) receive, within the at least one notification, a discrepancy type for each of the identified at least one material discrepancy, where the at least one notification comprises corresponding detail for each of the identified at least one material discrepancy based on the associated discrepancy type; and (ii) in response to identification of no material discrepancy between the delivered items in the second image and the one or more items in the first image, enable a delivery recipient or a purchaser to accept the delivery of the order as completed with no further action by the delivery agent.

One or more of the methods 600/700 further includes the processor executing code to provide at least one indication of at least one corrective action required to be taken from a group that includes: (i) re-positioning the delivered items and capturing and transmitting at least one third image of the repositioned delivered items; (ii) providing an on-location explanation of why the at least one material discrepancy exists; (iii) informing a delivery recipient of the at least one material discrepancy; (iv) enabling the delivery recipient or the purchaser to accept the delivery of the order as completed with no further action by the delivery agent; (v) enabling the delivery recipient or the purchaser to request a refund for one or more items confirmed to be missing from the delivered items; and (vi) requiring the delivery agent to return to the source to retrieve and deliver one or more items confirmed to be missing from the delivered items. Based on the corrective action that includes requesting a refund, the processor further executes codes to transmit the request for the refund to the order receiving server 220 to initiate processing of the request for the refund.

One or more of the methods 600/700 further includes the processor executing code to: (i) present a first prompt within a user interface of the electronic device for the delivery agent to capture the first image while the electronic device is located at the source; (ii) present a second prompt within the user interface for the delivery agent to capture the second image while the electronic device is located at the delivery address; and (iii) automatically trigger the comparison in response to receiving the second image from the at least one image capturing device. One or more of the methods 600/700 further includes the processor executing code to: (i) present the notification generated for each of the identified at least one material discrepancy on a display screen of the electronic device contemporaneously with the delivery of the order; and (ii) present a prompt requesting input of information related to a cause for each of the identified at least one material discrepancy.

With the described device embodiments, the electronic device: receives information of a first order requested from a source, including a delivery address for the first order; captures a first image of one or more items included in the first order at the source for delivery; subsequently captures, a second image comprising all items that were delivered contemporaneously with presenting the first order at the delivery address; and initiates a comparison of the delivered items within the second image with the one or more items within the first image. In response to identification of a material discrepancy between the delivered items in the second image and the items in the first image, the processor presents a notification indicating the material discrepancy and presents at least one corrective action required to be taken to address the material discrepancy.

Aspects of the present innovation are described above with reference to flowchart illustrations and/or block diagrams of methods, apparatus (systems) and computer program products according to embodiments of the innovation. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

As will be appreciated by one skilled in the art, embodiments of the present innovation may be embodied as a system, device, and/or method. Accordingly, embodiments of the present innovation may take the form of an entirely hardware embodiment or an embodiment combining software and hardware embodiments that may all generally be referred to herein as a “circuit,” “module” or “system.”

While the innovation has been described with reference to exemplary embodiments, it will be understood by those skilled in the art that various changes may be made, and equivalents may be substituted for elements thereof without departing from the scope of the innovation. In addition, many modifications may be made to adapt a particular system, device, or component thereof to the teachings of the innovation without departing from the essential scope thereof. Therefore, it is intended that the innovation not be limited to the particular embodiments disclosed for carrying out this innovation, but that the innovation will include all embodiments falling within the scope of the appended claims. Moreover, the use of the terms first, second, etc. do not denote any order or importance, but rather the terms first, second, etc. are used to distinguish one element from another.

The terminology used herein is for the purpose of describing particular embodiments only and is not intended to be limiting of the innovation. As used herein, the singular forms “a”, “an” and “the” are intended to include the plural forms as well, unless the context clearly indicates otherwise. It will be further understood that the terms “comprise” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present innovation has been presented for purposes of illustration and description but is not intended to be exhaustive or limited to the innovation in the form disclosed. Many modifications and variations will be apparent to those of ordinary skill in the art without departing from the scope and spirit of the innovation. The embodiments were chosen and described in order to best explain the principles of the innovation and the practical application, and to enable others of ordinary skill in the art to understand the innovation for various embodiments with various modifications as are suited to the particular use contemplated.

What is claimed is:

1. An electronic device comprising:
at least one image capturing device;
a communication subsystem that connects the electronic device to an ordering system computer to receive information about at least one order set for delivery;
a memory having a delivery order verification (DOV) module for verifying items delivered for an order set for delivery;
a processor communicatively coupled to the at least one image capturing device, the communication subsystem, and the memory, and which executes program code for the delivery order verification module which configures the processor to:
receive information of a first order set for delivery from a source, the information comprising a delivery address for the first order;
capture, via one of the at least one image capturing device, a first image comprising one or more items included in the first order at the source for delivery to the delivery address;
subsequently capture, via one of the at least one image capturing device, a second image comprising all items that were delivered at the delivery address contemporaneously with presenting the first order at the delivery address;
initiate a comparison of the delivered items within the second image with the one or more items within the first image; and
in response to identifying at least one material discrepancy between the delivered items in the second image and the one or more items in the first image, present at least one notification indicating the at least one material discrepancy.

2. The electronic device of claim 1, wherein to initiate the comparison, the processor:
identifies and compares the one or more items captured in the first image with the delivered items captured in the second image using an artificial intelligence (AI) engine to identify the at least one material discrepancy between the one or more items captured in the first image and the delivered items captured in the second image.

3. The electronic device of claim 2, wherein, in response to identifying the at least one material discrepancy between the one or more items captured in first image and the delivered items captured in second image, the processor:
determines a discrepancy type for each of the identified at least one material discrepancy between the one or more items captured in first image and the delivered items captured in the second image, wherein the at least one notification comprises corresponding detail for each of the identified at least one material discrepancy based on the associated discrepancy type.

4. The electronic device of claim 1, wherein to initiate the comparison the processor:
transmits, via the communication subsystem, the first image and the second image to a delivery order verification system, which performs image comparison via an artificial intelligence (AI) to identify items and characteristics of items within the first order and determines when the at least one material discrepancy exists that warrants the at least one notification to the delivery agent; and
receives the notification from the delivery order verification system, the notification including: a description of the at least one material discrepancy; and at least one indication of at least one corrective action required to be taken by a delivery agent in response to the material discrepancy.

5. The electronic device of claim 4, wherein, in response to a presence of multiple different discrepancy types between the one or more items captured in first image and the delivered items captured in the second image, the processor:
receives, within the at least one notification, a discrepancy type for each of the identified at least one material discrepancy, wherein the at least one notification comprises corresponding detail for each of the identified at least one material discrepancy based on the associated discrepancy type; and
in response to identification of no material discrepancy between the delivered items in the second image and the one or more items in the first image, enables a delivery recipient or a purchaser to accept the delivery of the first order as completed with no further action by the delivery agent.

6. The electronic device of claim 1, wherein the processor further provides at least one indication of at least one corrective action required to be taken from a group comprising:
re-positioning the delivered items and capturing and transmitting at least one third image of the repositioned delivered items;
providing an on-location explanation of why the at least one material discrepancy exists;
informing a delivery recipient of the at least one material discrepancy;
enabling the delivery recipient or the purchaser to accept the delivery of the first order as completed with no further action by a delivery agent;
enabling the delivery recipient or the purchaser to request a refund for one or more items confirmed to be missing from the delivered items; and
requiring the delivery agent to return to the source to retrieve and deliver one or more items confirmed to be missing from the delivered items.

7. The electronic device of claim 1, wherein the processor:
presents a first prompt within a user interface of the electronic device for a delivery agent to capture the first image while the electronic device is located at the source;
presents, while the electronic device is located at the delivery address, a second prompt within the user interface for the delivery agent to capture the second image; and
automatically triggers the comparison in response to receiving the second image from the at least one image capturing device.

8. The electronic device of claim 1, wherein the processor:
presents the notification generated for each of the identified at least one material discrepancy on a display screen of the electronic device contemporaneously with the presenting of the first order at the delivery address; and
presents a prompt requesting input from a delivery agent of information related to a cause for each of the identified at least one material discrepancy.

9. The electronic device of claim 6, wherein the processor:
in response to receiving a request for a refund for the at least one material discrepancy, transmits the request for the refund to the delivery order verification module to initiate processing of the request for the refund.

10. A method comprising:
receiving information of a first order requested for delivery from a source, the information comprising a delivery address for the first order;
capturing, via one of at least one image capturing device of an electronic device, a first image comprising one or more items included in the first order at the source for delivery to the delivery address;
subsequently capturing, via one of the at least one image capturing device of the electronic device, a second image comprising all items that were delivered at the delivery address contemporaneously with presenting the first order at the delivery address;
initiating a comparison of the delivered items within the second image with the one or more items within the first image; and
in response to identification of at least one material discrepancy between the delivered items captured in the second image and the one or more items captured in the first image, presenting, via an output device, at least one notification indicating the at least one material discrepancy.

11. The method of claim 10, wherein initiating the comparison comprises:
identifying and comparing the one or more items captured in the first image with the delivered items captured in the second image using an artificial intelligence (AI) engine to identify the at least one material discrepancy between the delivered items captured in the second image and the one or more items captured in the first image.

12. The method of claim 11, further comprising:
in response to identifying the at least one material discrepancy between the delivered items captured in second image and the one or more items captured in first image:
determining a discrepancy type for each of the identified at least one material discrepancy between the delivered items captured in the second image and the one or more items captured in first image, wherein the at least one notification comprises corresponding detail for each of the identified at least one material discrepancy based on the associated discrepancy type.

13. The method of claim 10, wherein initiating the comparison comprises:
transmitting, via the communication subsystem, the first image and the second image to a delivery order verification system, which performs image comparison via an artificial intelligence (AI) to identify items and characteristics of items within the first order and determines when the at least one material discrepancy exists that warrants the at least one notification to the delivery agent; and
receiving the at least one notification from the delivery order verification system, the at least one notification including: a description of the at least one material discrepancy; and at least one indication of at least one corrective action required to be taken by a delivery agent to address the material discrepancy.

14. The method of claim 13, further comprising:
in response to a presence of multiple different discrepancy types between the delivered items captured in the second image and the one or more items captured in first image:
receiving, within the at least one notification, a discrepancy type for each of the identified at least one material discrepancy, wherein the at least one notification comprises corresponding detail for each of the identified at least one material discrepancy based on the associated discrepancy type; and
in response to identification of no material discrepancy between the delivered items in the second image and the one or more items in the first image, enabling a delivery recipient or a purchaser to accept the delivery of the first order as completed with no further action by a delivery agent.

15. The method of claim 10, further comprising:
providing at least one indication of at least one corrective action required to be taken from a group comprising:
re-positioning the delivered items and capturing and transmitting at least one third image of the repositioned delivered items;
providing an on-location explanation of why the at least one material discrepancy exists;
informing a delivery recipient of the at least one material discrepancy;
enabling the delivery recipient or the purchaser to accept the delivery of the first order as completed with no further action by a delivery agent;
enabling the delivery recipient or the purchaser to request a refund for one or more items confirmed to be missing from the delivered items; and
requiring the delivery agent to return to the source to retrieve and deliver one or more items confirmed to be missing from the delivered items.

16. The method of claim 10, further comprising:
presenting a first prompt within a user interface of the electronic device for the delivery agent to capture the first image while the electronic device is located at the source;
presenting a second prompt within the user interface for the delivery agent to capture the second image while the electronic device is located at the delivery address; and
automatically triggering the comparison in response to receiving the second image from the at least one image capturing device.

17. The method of claim 10, further comprising:
presenting the notification generated for each of the identified at least one material discrepancy on a display screen of the electronic device contemporaneously with the delivery of the first order; and
presenting a prompt requesting input of information related to a cause for each of the identified at least one material discrepancy.

18. The method of claim 15, further comprising:
in response to receiving a request for a refund for the at least one material discrepancy, transmitting the request for the refund to the delivery order verification module of the electronic device to initiate processing of the request for the refund.

19. A computer program product comprising:
a computer readable storage device; and
program code on the computer readable storage device that when executed by a processor associated with an electronic device, the program code enables the electronic device to provide functionality of:
receiving information of a first order requested for delivery from a source, the information comprising a delivery address for the first order;
capturing, via one of at least one image capturing device of an electronic device, a first image comprising one or more items included in the first order at the source for delivery to the delivery address;
subsequently capturing, via one of the at least one image capturing device of the electronic device, a second image comprising all items that were delivered at the delivery address contemporaneously with presenting the first order at the delivery address;
initiating a comparison of the delivered items within the second image with the one or more items within the first image; and
in response to identification of at least one material discrepancy between the delivered items captured in the second image and the one or more items captured in the first image, presenting at least one notification indicating the at least one material discrepancy.

20. The computer program product of claim 19, wherein the program code that enables the electronic device to provide the functionality of initiating the comparison comprises code that enables the electronic device to provide functionality of:
identifying and comparing the one or more items captured in the first image with the delivered items captured in the second image using an artificial intelligence (AI) engine to identify the at least one material discrepancy between the delivered items captured in the second image and the one or more items captured in the first image;
in response to identifying the at least one material discrepancy between the delivered items captured in second image and the one or more items captured in first image, determining a discrepancy type for each of the identified at least one material discrepancy between the delivered items captured in the second image and the one or more items captured in first image, wherein the at least one notification comprises corresponding detail for each of the identified at least one material discrepancy based on the associated discrepancy type; and
presenting at least one indication of at least one corrective action required to be taken by a delivery agent to address the material discrepancy.
